(19) United States
(12) Patent Application Publication
(10) Pub. No.: US 2016/0052057 A1
(43) Pub. Date: Feb. 25, 2016

(54) GAS TURBINE COMPONENT MANUFACTURING

(71) Applicant: UNITED TECHNOLOGIES CORPORATION, Hartford, CT (US)

(72) Inventor: JinQuan Xu, Greenwich, RI (US)

(73) Assignee: United Technologies Corporation, Hartford, CT (US)

(21) Appl. No.: 14/779,867

(22) PCT Filed: Mar. 25, 2014
(86) PCT No.: PCT/US2014/031701

§ 371 Date: Sep. 24, 2015

Related U.S. Application Data
(60) Provisional application No. 61/806,292, filed on Mar. 28, 2013.

(51) Int. Cl. B22F 3/105; F01D 5/18; B23H 9/10; B23K 15/00; B23H 9/00

(52) U.S. Cl. CPC B22F 3/1055; B23K 15/0086; B23H 9/006; B23H 9/10; F01D 5/187; B33Y 10/00

(57) ABSTRACT

A method of fabricating a gas turbine engine component comprises building and machining a hollow workpiece. The workpiece is built via additive manufacturing to create a coarse structure that turbulates cooling flow. At least a portion of the workpiece is machined via subtractive manufacturing to create a smooth surface that promotes laminar flow.

### BACKGROUND

The present invention relates generally to gas turbine engines, and more particularly to methods and systems for fabricating gas turbine engine workpieces such as blades, vanes, and air seals.

Gas turbine engines are internal combustion engines with upstream compressors and downstream turbines fluidly connected through a combustor. Gas turbines operate according to the Brayton cycle, extracting energy from high-pressure, high-temperature airflow downstream of the combustor, where fuel is injected into pressurized airflow from the compressor, and ignited. Many gas turbine engine components guide airflow, either as a working fluid of the engine, or for cooling. Blades and vanes, for instance, are airfoil components with smooth outer surfaces configured to guide working fluid for compression (in a compressor) or energy extraction (in a turbine).

Some turbine components use secondary airflow for cooling, to alleviate otherwise harmful component heating during engine operation. Some components run secondary airflow through internal channels of turbine components (e.g. blades, vanes, air seals) for convective cooling. Other components expel secondary airflow from internal channels onto surfaces of turbine components to create laminar cooling airflow across an external surface.

### SUMMARY

According to one embodiment of the present invention, a method of fabricating a gas turbine engine component comprises building and machining a hollow workpiece. At least a portion of the workpiece is built via additive manufacturing to create a coarse structure that turbulates airflow. The workpiece is machined via subtractive manufacturing to create a smooth surface that promotes laminar flow.

According to a second embodiment of the present invention, a system for fabricating gas turbine engine components comprises an additive manufacturing station and a subtractive manufacturing station. The additive manufacturing station is configured to build a hollow workpiece with a coarse interior structure that turbulates airflow. The subtractive manufacturing station is configured to machine the hollow workpiece to create a smooth exterior structure that promotes laminar flow.

### BRIEF DESCRIPTION OF THE DRAWINGS

FIG. 1 is a schematic diagram of a rapid manufacturing system.

FIG. 2 is a simplified cross-sectional view of a hollow workpiece fabricated using the rapid manufacturing system of FIG. 1

FIG. 3 is a flow diagram illustrating a method used by the rapid manufacturing system of FIG. 1 to create the hollow workpiece of FIG. 2.

### DETAILED DESCRIPTION

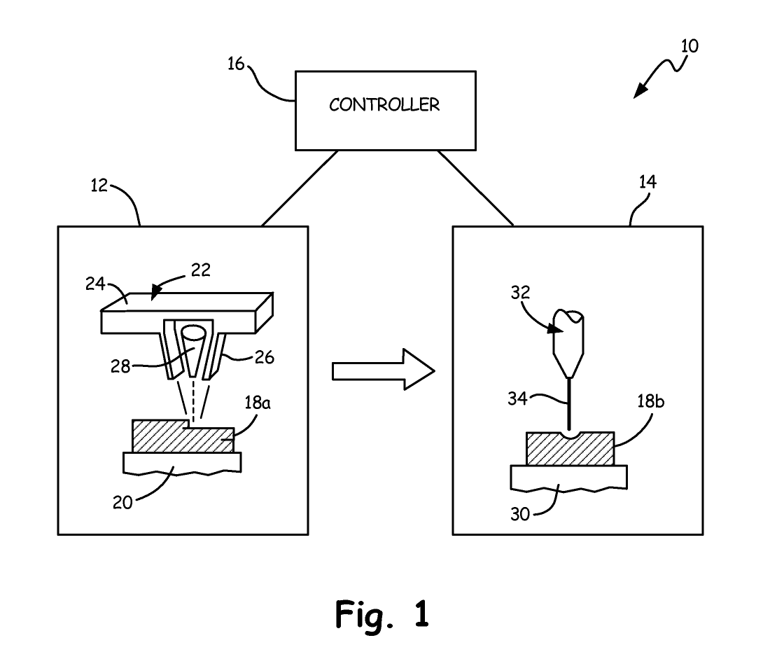

FIG. 1 is a schematic diagram of rapid manufacturing system 10, which comprises additive manufacturing subsystem 12, subtractive manufacturing subsystem 14, and controller 16, and is operable to fabricate a workpiece (shown as workpieces 18a and 18b, and referred to generically as workpiece 18) in steps. Additive manufacturing subsystem 12 comprises additive manufacturing platform 20 and additive manufacturing tool 22 (with pulverant material reservoir 24, pulverant material dispensers 26, and laser guide 28), and subtractive manufacturing subsystem 14 comprises subtractive manufacturing platform 30 and subtractive manufacturing tool 32 (with machining electrode 34). Additive manufacturing subsystem 12 builds workpiece 18a, which subtractive manufacturing subsystem 14 then machines as workpiece 18b to create a final gas turbine engine component. Workpieces 18a and 18b are represent stages in the fabrication of workpiece 18.

Controller 16 is a logic-capable device that manages additive and subtractive manufacturing of workpiece 18. Controller 16 may, for instance, be a microprocessor incorporated into additive manufacturing subsystem 12 and/or subtractive manufacturing subsystem 14, or a separate user workstation. Controller 16 can, for instance, be programmed with a part design describing workpiece 18 in three dimensions. Alternatively, controller 16 may specify the steps to fabricating workpiece 18a and machining workpiece 18b without including a full design of the finished gas turbine component. Although controller 16 is depicted as a single unitary component, some embodiments of workpiece fabrication system 10 may use more than one controller 16. In particular, some embodiments of workpiece fabrication system 10 may include separate controllers 16 associated with each manufacturing station (e.g. with additive manufacturing subsystem 12 and subtractive manufacturing subsystem 14).

In the depicted embodiment, additive manufacturing subsystem 12 and subtractive manufacturing subsystem 14 are dedicated manufacturing stations for additively forming workpiece 18a, and subtractively machining workpiece 18b. Although only two such subsystems are shown in FIG. 1, some embodiments of the present invention may include multiple additive manufacturing stations and/or subtractive manufacturing system. In some embodiments, workpiece 18 may be machined using multiple stages of alternating additive and subtractive manufacturing techniques. In still other embodiments, additive and subtractive manufacturing subsystems 12 and 14 may be combined into a single multi-function system capable of performing both additive and subtractive manufacturing.

Additive manufacturing subsystem 12 is depicted as a direct metal laser sintering (DMLS) system, such that additive manufacturing tool 22 comprises pulverant material reservoir 24, pulverant material dispensers 26, and laser guide 28. Pulverant material reservoir 24 is any container suitable for holding pulverant material suitable for use in additive manufacturing, such as fine powders of conductors or insulators. For example, this pulverant material may be superalloy powder, or ceramics powder. Pulverant material dispensers 26 may be opened or closed to selectively restrict flow of pulverant material to workpiece 18a or platform 20. Laser guide 28 is a laser emitter or focusing element that directs a laser to soften, melt or sinter pulverant material deposited by pulverant material dispensers 26. Additive manufacturing tool 22 builds workpiece 18a layer-by-layer by depositing and sintering pulverant atop platform 20. Platform 20 may, for instance, be a mobile platform configured to position a working region of workpiece 18a beneath laser guide 28. Alternatively, laser guide 28 and/or additive manufacturing tool 22 as a whole may be a movable or directable device capable of adjusting this working region relative to a stationary embodiment of platform 20.

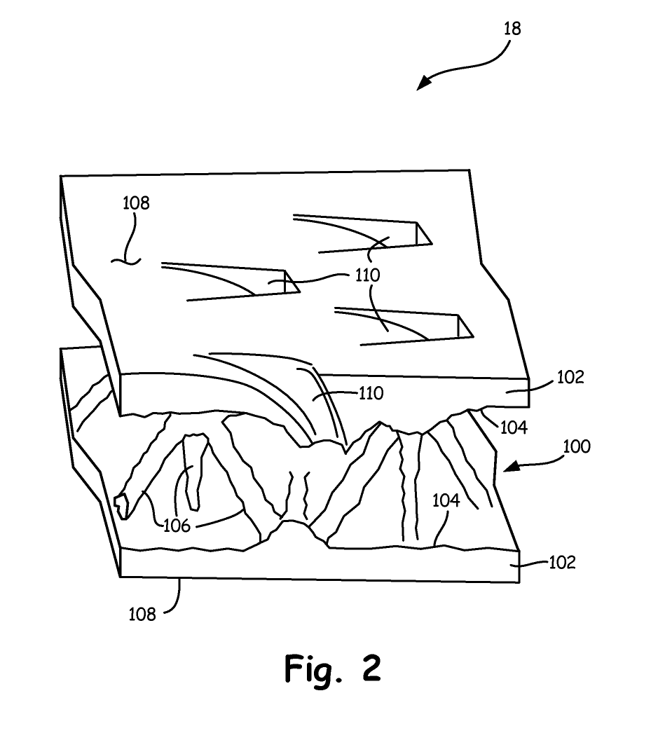

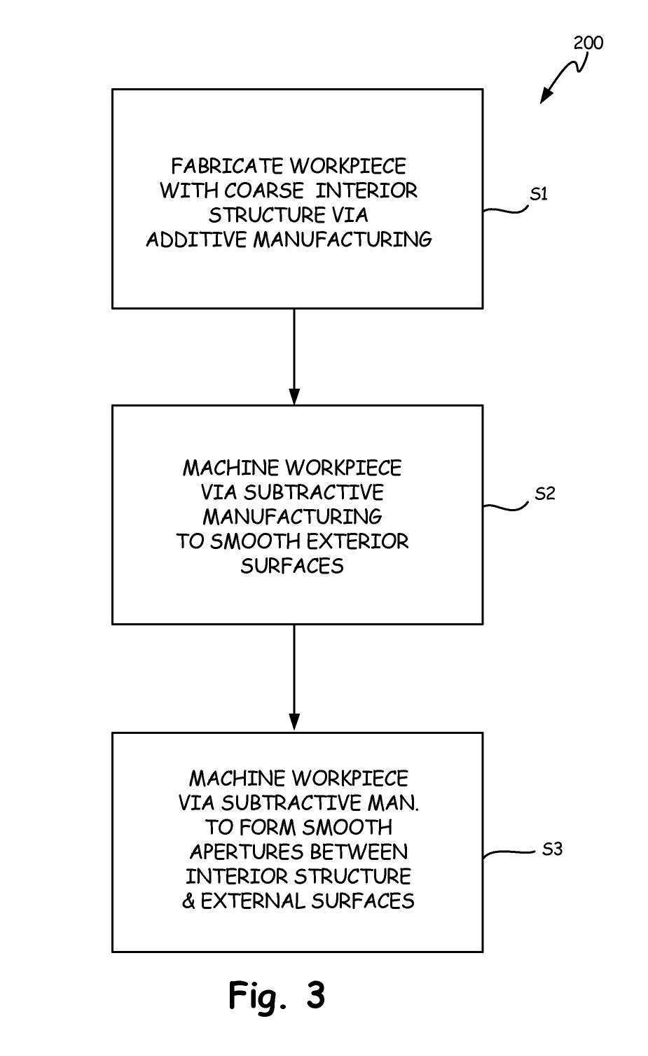

Although additive manufacturing subsystem 12 is depicted as a DMLS system, a variety of other additive manufacturing tools may alternatively be used, including laser additive manufacturing (LAM) tools (e.g. laser engineered net shaping (LENS), laser powder deposition (LPD), or selective laser sintering (SLS) apparatus) or electron beam machining tools (e.g. electron beam melting (EBM) or electron beam wire (EBW) apparatus). In some embodiments, additive manufacturing subsystem 12 may incorporate a plurality of different additive manufacturing tools 22 that operate sequentially or in parallel. All embodiments of additive manufacturing subsystem 12 build workpiece 18a layer-by-layer atop additive manufacturing platform 20. Additive manufacturing subsystem 12 fabricates workpiece 18a as a hollow component with coarse or irregular surfaces, as described below with respect to FIGS. 2 and 3.

Subtractive manufacturing subsystem 14 is depicted as a wire-cut electrical discharge machining (EDM) system with machining electrode 34. Subtractive manufacturing subsystem 14 etches, cuts, or otherwise ablates workpiece 18b. In the depicted embodiment, subtractive manufacturing subsystem 14 operates by removing material from workpiece 18b by a series of rapidly recurring current discharges between machining electrode 34 and workpiece 18b. Subtractive manufacturing subsystem 14 smoothes at least one surface of workpiece 18b, removing surface irregularities of the coarse structure produced by additive manufacturing subsystem 12.

Although subtractive manufacturing subsystem 14 is depicted as a wire-cut EDM system, a variety of other subtractive manufacturing tools for controlled material removal may alternatively be used, including other forms of EDM (such as die-sink EDM or sinker EDM), mechanical milling or boring, and/or chemical etching. As with additive manufacturing subsystem 12, some embodiments of subtractive manufacturing subsystem 14 may include multiple different additive manufacturing tools 22 that operate sequentially or in parallel. All embodiments of subtractive manufacturing system 14 machine workpiece 18b to produce smooth outer surfaces that promote laminar or other cooling flow, as described below with respect to FIGS. 2 and 3.

FIG. 2 is a cutaway view of a finished version of workpiece 18, as fabricated by rapid manufacturing system 10. Workpiece 18 is a hollow gas turbine engine component with interior 100, outer walls 102, inner surfaces 104, inner structure 106, outer surfaces, and air holes 110, such as film cooling holes. Outer walls 102 and inner structure 106 are structural components that make up the body of workpiece 18. Inner surfaces 104 are coarse interior surfaces of outer walls 102 that define interior space 100. Outer surfaces 108 are smooth exterior surfaces of outer walls 102 that define the outer extent of workpiece 18. Interior structure 106 is a support structure that connects outer walls 102 without blocking airflow (or cooling flow) through interior space 100. Air holes 110 are cooling holes that permit egress of secondary airflow from interior space 100, and promote laminar flow along outer surfaces 108.

Workpiece 18 is fabricated by first building outer walls 102 and inner structure 106 using additive manufacturing subsystem 12, then smoothing outer surface 108 and forming air holes 110 using subtractive manufacturing subsystem 14. In the depicted embodiment, inner structure 106 comprises a lattice of branching supports that extend between outer walls 102. Inner structure 106 may take a variety of forms, all of which support and connect outer walls 102.

As described above with respect to FIG. 1, the structures fabricated by additive manufacturing subsystem 12 are relatively coarse, and include bumps, ridges, or irregularities. These coarse features remain in the finished state of workpiece 18 on inner surfaces 104 and interior structure 106, but are machined away from outer surfaces 108 and air holes 110. In the resulting final structure of workpiece 18, interior space 100 serves as a cooling passage with numerous protrusions (e.g. from interior structure 106) and coarse features (e.g. irregularities, ridges, or bumps on interior structure 106 and/or inner surfaces 104) that turbulate cooling flow such as airflow. Some embodiments of interior structure 106 may define mutually isolated cooling passages within interior space 100. The turbulence caused by protrusions and coarse features of interior space 100 improves convective cooling of workpiece 18 by secondary airflow through interior space 100, and increases interface for enhancing heat transfer efficiency. The smooth contours of air holes 110 and outer surface 108, by contrast, promote laminar flow and facilitate to establish cooling air films along that exterior surface 108. Workpiece 18 thus promotes turbulent interior airflow and laminar exterior airflow.

FIG. 3 is a flow diagram illustrating method 200 by which rapid manufacturing system produces workpiece 18. Workpiece 18 may, for instance, be a gas turbine blade, vane, or air seal, or a microcircuit cooling structure. First, additive manufacturing subsystem 12 builds workpiece 18. (Step S1). As described above with respect to FIG. 2, workpiece 18 has a coarse interior with inner surfaces 104 and interior structure 106 that promote turbulent flow. Outer surfaces 108 are initially also coarse, and outer walls 102 need not initially include any air holes 110. Next, subtractive manufacturing subsystem 14 removes material from outer walls 102 to smooth outer surfaces 108. (Step S2). Outer surfaces 108 may, for instance, be airflow surfaces of a blade, vane, or air seal defining a flow path for working fluid through a gas turbine engine. Subtractive manufacturing subsystem 14 also removes material from outer walls 102 to form air holes 110 or polish air holes 110 extending from at least one outer surface 108 to interior space 100. (Step S3). Air holes 110 carry secondary airflow from interior space onto outer surface 108 to create laminar cooling flow that convectively cools workpiece 18 without impeding working fluid airflow through the gas turbine engine.

Rapid manufacturing system 10 executes method 200 to rapidly and inexpensively fabricate workpiece 18 with advantageous cooling features including a coarse interior that promotes turbulent airflow, and a smooth exterior with smooth air holes to promote laminar or other cooling airflow.

### DISCUSSION OF POSSIBLE EMBODIMENTS

The following are non-exclusive descriptions of possible embodiments of the present invention.

A method of fabricating a gas turbine engine component, the method comprising building and machining a hollow workpiece. The workpiece is built via additive manufacturing to create a coarse structure that turbulates cooling flow. At least a portion of the workpiece is machined via subtractive manufacturing to create a smooth surface that promotes laminar flow.

The method of the preceding paragraph can optionally include, additionally and/or alternatively, any one or more of the following features, configurations, and/or additional components:

The coarse structure is situated in an interior region of the hollow workpiece.

The coarse structure comprises an interior cooling passage through the hollow workpiece.

The smooth structure is situated at an exterior surface of the hollow workpiece.

The smooth structure comprises at least one cooling air hole extending from an interior region of the hollow workpiece to the exterior surface.

Building the hollow workpiece via additive manufacturing comprises forming the hollow workpiece layer-by-layer via direct metal laser sintering.

Building the hollow workpiece via additive manufacturing comprises forming the hollow workpiece layer-by-layer via electron beam machining.

Subtractive manufacturing comprises ablating portions of the hollow workpiece using electrical discharge machining

The hollow workpiece is a gas turbine blade.

The hollow workpiece is a gas turbine vane.

The hollow workpiece is a gas turbine air seal.

A system for fabricating gas turbine engine components comprises an additive manufacturing tool and a subtractive manufacturing tool. The additive manufacturing tool is configured to build a hollow workpiece with a coarse interior structure that turbulates cooling flow. The subtractive manufacturing tool is configured to machine the hollow workpiece to create a smooth exterior structure that promotes laminar flow.

The system of the preceding paragraph can optionally include, additionally and/or alternatively, any one or more of the following features, configurations, and/or additional components:

The additive manufacturing tool is a direct metal laser sintering apparatus.

The additive manufacturing tool is an electron beam machining apparatus.

The subtractive manufacturing tool is an electrical discharge machining apparatus.

The smooth exterior structure comprises a cooling hole extending from a hollow interior of the hollow workpiece to the smooth interior structure.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of fabricating a gas turbine component, the method comprising:
building a hollow workpiece via additive manufacturing to create a coarse structure that turbulates cooling flow; and
machining at least a portion of the hollow workpiece via subtractive manufacturing to create a smooth structure that promotes laminar flow.

2. The method of claim 1, wherein the coarse structure is situated in an interior region of the hollow workpiece.

3. The method of claim 1, wherein the coarse structure comprises an interior cooling passage through the hollow workpiece.

4. The method of claim 1, wherein the smooth structure is situated at an exterior surface of the hollow workpiece.

5. The method of claim 4, wherein the smooth structure comprises at least one cooling hole extending from an interior region of the hollow workpiece to the exterior surface.

6. The method of claim 1, wherein building the hollow workpiece via additive manufacturing comprises forming the hollow workpiece layer-by-layer via direct metal laser sintering.

7. The method of claim 1, wherein building the hollow workpiece via additive manufacturing comprises forming the hollow workpiece layer-by-layer via electron beam machining.

8. The method of claim 1, wherein subtractive manufacturing comprises ablating portions of the hollow workpiece using electrical discharge machining.

9. The method of claim 1, wherein the hollow workpiece is a gas turbine blade, vane, or air seal.

10. The method of claim 1, wherein the hollow workpiece is a microcircuit cooling structure.

11. A system for fabricating gas turbine components, the system comprising:
an additive manufacturing tool configured to build a hollow workpiece with a coarse interior structure that turbulates cooling flow; and
a subtractive manufacturing tool configured to machine the hollow workpiece to create a smooth exterior structure that promotes laminar flow.

12. The system of claim 11, wherein the additive manufacturing tool is a direct metal laser sintering apparatus.

13. The system of claim 11, wherein the additive manufacturing tool is an electron beam machining apparatus.

14. The system of claim 11, wherein the subtractive manufacturing tool is an electrical discharge machining apparatus.

15. The system of claim 11, wherein the smooth exterior structure comprises a cooling hole extending from a hollow interior of the hollow workpiece to the smooth exterior structure.
